(19) United States
(12) Patent Application Publication
(10) Pub. No.: US 2015/0022045 A1
(43) Pub. Date: Jan. 22, 2015

(54) Electrical Rotating Machine

(71) Applicant: Hitachi Automotive Systems, Ltd., Hitachinaka-shi, Ibaraki (JP)

(72) Inventors: Shuya Hagiwara, Tokyo (JP); Koji Obata, Tokyo (JP)

(21) Appl. No.: 14/376,033

(22) PCT Filed: Dec. 7, 2012
(86) PCT No.: PCT/JP2012/081732

§ 371 Date: Jul. 31, 2014

(30) Foreign Application Priority Data
Feb. 1, 2012 (JP) 2012-019415

(51) Int. Cl. H02K 3/38

(52) U.S. Cl. CPC H02K 3/38; H02K 2203/06
USPC 310/201

(57) ABSTRACT

Reliability related to an insulating process of conductor connection terminals of an electrical rotating machine stator using segment conductors is improved. An electrical rotating machine is configured so that stator coils 13 are inserted into slots 111 of a stator core 11, the stator coil 13 is formed by electrically connecting a stator coil connection terminal 41 of a segment conductor, the stator core 11 and the stator coils 13 are fixed with resin, and insulating members 24 and 25 are arranged so as to weave between the stator coil connection terminals 41 adjacent to each other in a circumferential direction.

### TECHNICAL FIELD

The present invention relates to an electrical rotating machine.

### BACKGROUND ART

Electrical rotating machines such as electric motors that are closely related to industry and daily life are infrastructure devices that support modern society. Among them, an end-use-oriented motor, which has a relatively small capacity and is directly connected to daily life, often functions as an auxiliary component that supports another functional device, so that the motor is required to be small and light as much as possible. In particular, in engine/motor hybrid cars and electric vehicles that are spreading widely for global environment protection, a power source motor is strongly required to be small and light. As a means for reducing the size of the motor, there is an idea of increasing output power density by increasing the conductor density in a slot of an electrical rotating machine stator. To realize this, instead of a conventional structure in which a serial magnet wire is inserted into the slot, a structure is employed in which a conductor is divided into a large number of segment conductors and inserted into the slots and then the segment conductors are electrically connected to form a coil.

### CITATION LIST

### Patent Literature

Patent Literature 1: Japanese Unexamined Patent Application Publication No. 2005-020943

Patent Literature 2: Japanese Unexamined Patent Application Publication No. 2010-104232

Patent Literature 3: Japanese Unexamined Patent Application Publication No. H07(1995)-298530

### SUMMARY OF INVENTION

### Technical Problem

In a stator using segment conductors, the segment conductors are fitted into the stator and then the segment conductors are electrically connected. However, it is necessary to peel insulating membranes on connection portions of the segment conductors when connecting the segment conductors, so that an insulation process is performed again after connecting the segment conductors. As a method of insulating the connection portions, for example, there is a method of applying an insulating resin as described in Patent Literature 1. However, it is difficult to accurately manage an applying amount of resin. Generally, a thick resin can be applied to a flat portion of a conductor. On the other hand, the resin at a corner portion tends to be thin. When trying to apply a resin of sufficient thickness to a corner portion, an excessive resin is attached to a flat portion. In an inverter-driven motor which has become mainstream in recent years, distribution of inverter surge voltage is uneven, and the closer to a power supply a coil is, the more the inverter surge voltage is distributed to the coil. In this case, it is desired to optimize the thickness of the insulating membrane according to the distribution of voltage to each coil. However, it is difficult to control an applying amount of insulating resin. Further, there is a risk that the applied resin is peeled off by vibration of the motor while the motor is running or a pressure from cooling fluid and the peeled resin becomes a foreign obstacle. The larger the thickness of the applied resin, the larger the unbalance of stress and the more easily crack or peeling occurs.

As an extension of the method of applying the insulating resin, there is a method of largely molding a coil end including the connection portion of the segment conductor with the insulating resin. An example of the method is described in Patent Literature 2. However, the larger the volume of the resin, the larger the risk that a crack occurs due to vibration during operation or heat cycles. Further, when the volume of the resin is large, there is a problem that the heat dissipation performance of the coil is degraded.

As a method that does not apply the insulating resin, there is a method that inserts a sheet-shaped insulating member as disclosed in Patent Literature 3. However, the disclosed example does not consider the insulating structure of the conductor connection portion.

An object of the present invention is to improve reliability related to an insulating process of connection portions of a segment-wrapped stator coil.

### Solution to Problem

To solve the above problem, for example, an electrical rotating machine may be configured so that stator coils are inserted into slots of a stator core, the stator coil is formed by electrically connecting a connection terminal of a segment conductor, the stator core and the stator coils are fixed with resin, and an insulating member is arranged so as to weave between the connection terminals adjacent to each other in a circumferential direction.

### Advantageous Effects of Invention

According to the present invention, it is possible to improve reliability related to an insulating process of coil connection portions of an electrical rotating machine including segment-wrapped stator coils.

### BRIEF DESCRIPTION OF DRAWINGS

FIG. 1 is a perspective view of an electrical rotating machine of an embodiment of the present invention.

FIG. 2 is a perspective view showing a form of inserting a segment conductor in a stator core of an embodiment of the present invention.

FIG. 3 is a cross-sectional view showing a connection order of the segment conductors inserted into the stator core.

FIG. 4 is a development diagram showing a connection form of the segment conductors of the electrical rotating machine.

FIG. 5 is a partial perspective view of a portion in which insulating members are fitted to segment conductor connection terminals in an embodiment of the present invention.

FIG. 6 is a partial plan view of a portion in which insulating members are fitted to segment conductor connection terminals in an embodiment of the present invention.

FIG. 7 is a perspective partial cross-sectional view of a portion in which insulating members are fitted to segment conductor connection terminals in an embodiment of the present invention.

FIG. 8 is a partial plan view of a portion in which insulating members are fitted to segment conductor connection terminals in another embodiment of the present invention.

FIG. 9 is a partial plan view of a portion in which insulating members are fitted to segment conductor connection terminals in further another embodiment of the present invention.

FIG. 10 is a partial plan view of a portion in which insulating members are fitted to segment conductor connection terminals in further another embodiment of the present invention.

FIG. 11 is a conceptual diagram showing a configuration example of consecutive cylindrical insulating members used in an embodiment of the present invention.

FIG. 12 is a conceptual diagram showing a configuration example of consecutive cylindrical insulating members used in another embodiment of the present invention.

FIG. 13 is a conceptual diagram showing a configuration example of consecutive cylindrical insulating members used in further another embodiment of the present invention.

FIG. 14 is a partial plan view of a portion in which consecutive cylindrical insulating members are fitted to segment conductor connection terminals in further another embodiment of the present invention.

FIG. 15 is a cross-sectional view in a coil longitudinal direction of insulating members fitted to segment conductor connection terminals in an embodiment of the present invention.

FIG. 16 is a cross-sectional view in a coil longitudinal direction of insulating members fitted to segment conductor connection terminals in another embodiment of the present invention.

FIG. 17 is a perspective view of a configuration in which an integrated insulating member is fitted to segment conductor connection terminals in an embodiment of the present invention.

FIG. 18 is a perspective view of a plurality of insulating members fitted to segment conductor connection terminals in an embodiment of the present invention.

FIG. 19 is a perspective view of an endless insulating member fitted to segment conductor connection terminals in an embodiment of the present invention.

FIG. 20 is a partial plan view of a configuration in which an insulating member is locally and additionally arranged at segment conductor connection terminals in an embodiment of the present invention.

FIG. 21 is a process flowchart for manufacturing an electrical rotating machine stator in which insulating members are arranged at segment conductor connection terminals in an embodiment of the present invention.

### DESCRIPTION OF EMBODIMENTS

Hereinafter, embodiments of the present invention will be described with reference to the drawings.

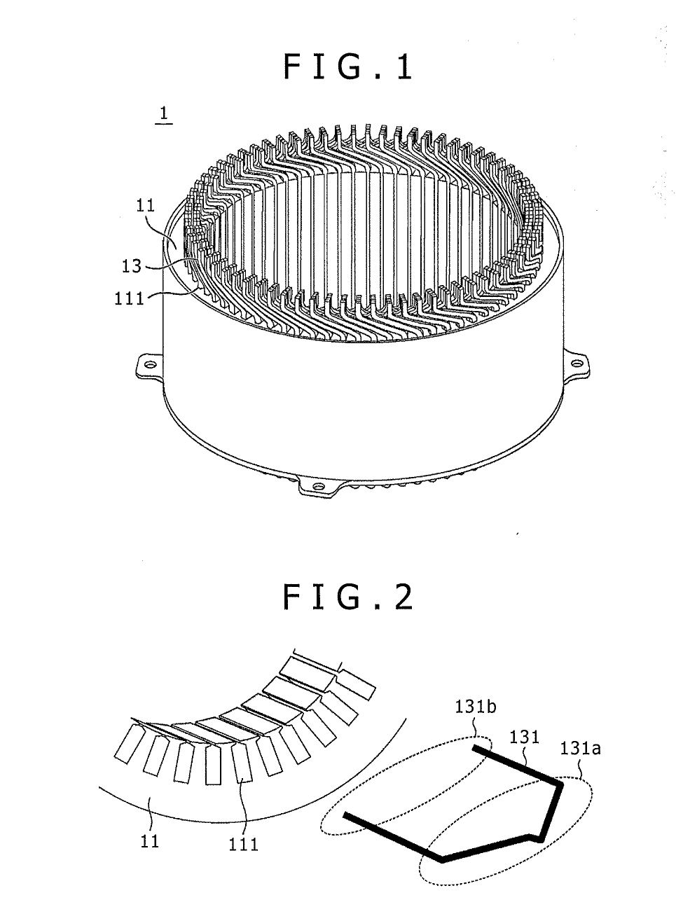

FIG. 1 is a general view of a stator 1 of an electrical rotating machine using segment conductors. A stator coil 13 is inserted into a slot 111 provide in a stator core 11. In the example of FIG. 1, tens of slots are formed in the stator core 11 and the stator coil 13 is inserted into each of the slots.

FIG. 2 is an example of a method of inserting the stator coil 13 into the stator core 11. A segment conductor 131 is a segment conductor in which one end 131a is formed by folding the segment conductor and the other ends 131b are released linearly. The segment conductor 131 is inserted into the slot 111 of the stator core 11 from the open ends 131b. The segment conductors 131, the number of which is determined by design specifications of the electrical rotating machine, are inserted into one slot 111. An electric circuit is not established by only one segment conductor, so that a plurality of segment conductors after being fitted into the stator core 11 are connected to form a circuit.

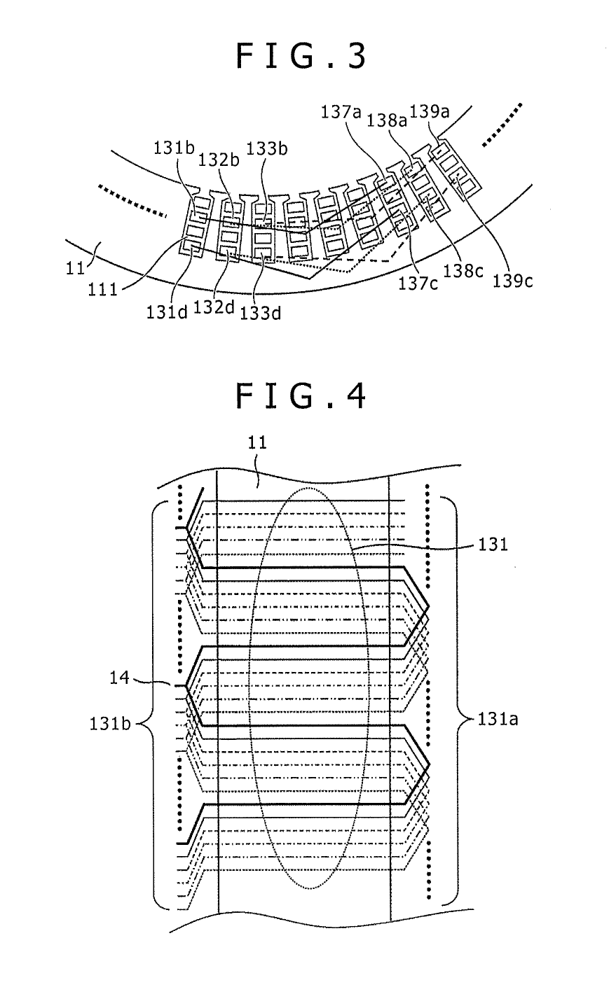

FIG. 3 is a cross-sectional view of the stator core 11. FIG. 3 shows an example in which four segment conductors are inserted into one slot 111. Regarding the inner two segment conductors, 131b and 137a are connected, 132b and 138a are connected, 133b and 139a, and so on are connected, so that an electric circuit is formed. The intervals between the segment conductors are determined by the number of the slots and the number of serial-parallel circuits, so that the intervals between the segment conductors shown in FIG. 3 is an example. Similarly, regarding the outer two segment conductors, 131d and 137c are connected, 132d and 138c are connected, 133d and 139c, and so on are connected.

FIG. 4 is a development diagram showing an example of a connection form of the segment conductors. The open end 131b of the segment conductor 131 inserted into the stator core 11 is folded and formed into a predetermined shape and then the end portion is electrically connected to form a circuit. At this time, a connection terminal 14 is formed. As a connection method, welding, silver alloy brazing, soldering, mechanical crimping, or the like is used. In one stator, (the number of slots)×(the number of segment conductors in one slot)/2 of connection terminals are formed.

As the segment conductor, an enamel coated wire having a cross-sectional shape of a circle (commonly called a circular section wire), a rectangle (commonly called a rectangular section wire), a modified shape of these, or a composite shape of these is used. In recent years, use of the rectangular section wire is increasing in order to improve the space factor of conductors in the slot. As an insulating structure of the wire, in addition to the enamel-coating, a structure in which a thin sheet insulator or a tape-shaped insulator is wrapped around the wire is employed. In any insulating structure, it is necessary to remove an insulating member at a connection portion in order to electrically connect the wires. After connecting the wires, it is necessary to insulate the wires again in order to prevent the wires from being short-circuited to an adjacent connection portion.

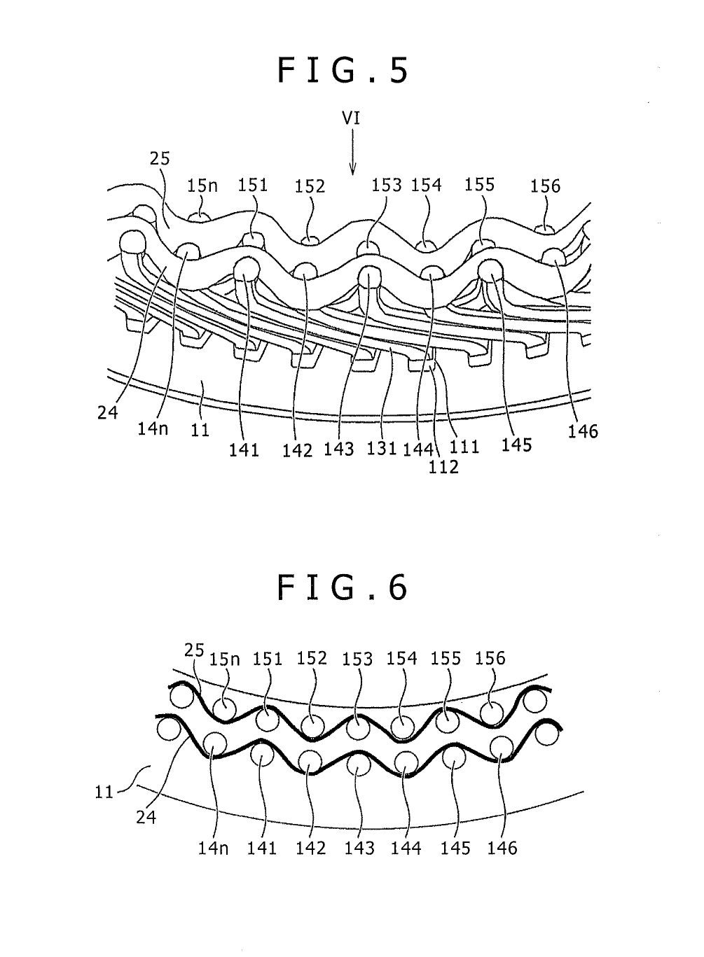

FIG. 5 is an enlarged perspective view of the connection terminals 14 on the segment conductor connection side of the stator 1, which shows an example of the insulating structure of the connection terminals 14 of the present invention. The segment conductor 131 is inserted into the slot 111 provide in the stator core 11 through a slot liner 112 formed of an insulating material. Although FIG. 5 shows an example in which a rectangular section wire is used as the segment conductor, a circular section wire can also be used in the same manner. The end portion of the segment conductor 131 is connected to another segment conductor and a connection terminal 14 is formed. Further, connection terminals 142, 143, . . . , and 14n are consecutively formed in the circumferential direction of the stator 1. Here, n is the number of the slots. The present embodiment shows an example in which four segment conductors are arranged in one slot 111, so that another row of connection terminals 151, 152, . . . , and 15n is formed in the radial direction. Continuous insulating members 24 and 25 are arranged between the connection terminals adjacent to each other.

FIG. 6 shows positional relationship between the connection terminals and the insulating members in plan view seen from the VI direction in FIG. 5. In the present embodiment, four segment conductors are inserted in one slot, so that two rows of connection terminals, which are the row of 141, 142, . . . , and 14n and the row of 151, 152, . . . , and 15n, are coaxially formed. The insulating members 24 and 25 are arranged in a shape in which the insulating members 24 and 25 are folded and inserted alternately between the connection terminals adjacent to each other in the circumferential direction. Here, either one of the insulating members 24 and 25 is arranged to be present between the connection terminals 141 and 151, 142 and 152, . . . , and 14n and 15n, each two of which are adjacent to each other in the radial direction, so that the insulating member is arranged between all the connection terminals adjacent to each other in the radial direction. In other words, the insulating member 24 or 25 is arranged between the connection terminals adjacent to each other in the circumferential direction, the insulating member continues in the circumferential direction, and the front surface (one surface) of the insulating member 24 or 25 and the back surface (the other surface) are alternately in contact with the welded connection terminals adjacent to each other. This is a configuration in which, for example, the front surface of the insulating member 24 (outer side in the radial direction of the stator 1) is in contact with the connection terminal 141 and the back surface of the insulating member 24 (inner side in the radial direction of the stator 1) is in contact with the connection terminal 142 or the connection terminal 14n which are adjacent to the connection terminal 141.

As the insulating members 24 and 25 used here, nonwoven fabric paper, tape woven by fiber, polymer film, inorganic particle insulator, and composite of these materials can be used. Further, a molded insulator formed by resin-impregnating each of the above materials or the composite of these materials can be used.

Although the intervals between the segment conductor connection terminals adjacent to each other are originally designed to secure a predetermined insulating distance, the insulating distance may be not sufficient due to manufacturing variation. Further, the insulating distance may get close to a distance, where the insulating property is impaired, due vibration during operation. In these cases, according to the present embodiment described above, the insulating member is arranged between the segment conductor connection terminals adjacent to each other, so that it is possible to prevent electric breakdown from occurring even when the insulating distance between the connection terminals is not sufficient.

Further, when a material having elasticity, such as a polymer film or a composite material including a polymer film is used as the insulating members 24 and 25, it is possible to improve reliability of the structure. In other words, when a material having elasticity is folded and fitted by being deformed within an elastic deformation range, the connection terminals are pressed by a restoring force for the bend portions to return to a straight shape, so that it is possible to prevent the insulating members from coming off.

It is possible to more reliably prevent the insulating members from coming off by fitting the insulating members to the connection terminals and then fixing together the insulating members and the connection terminals by resin. The process of fixing by resin can be performed at the same time as a process of fixing the core and the coil together by resin. As the resin used for the fixing, a thermosetting resin such as epoxy varnish and unsaturated polyester varnish can be used. Further, a volatile organic resin can be used. As a method for coating with a resin, a dropping impregnating method, an immersion impregnating method, a spraying method, a brush coating method, and the like can be used.

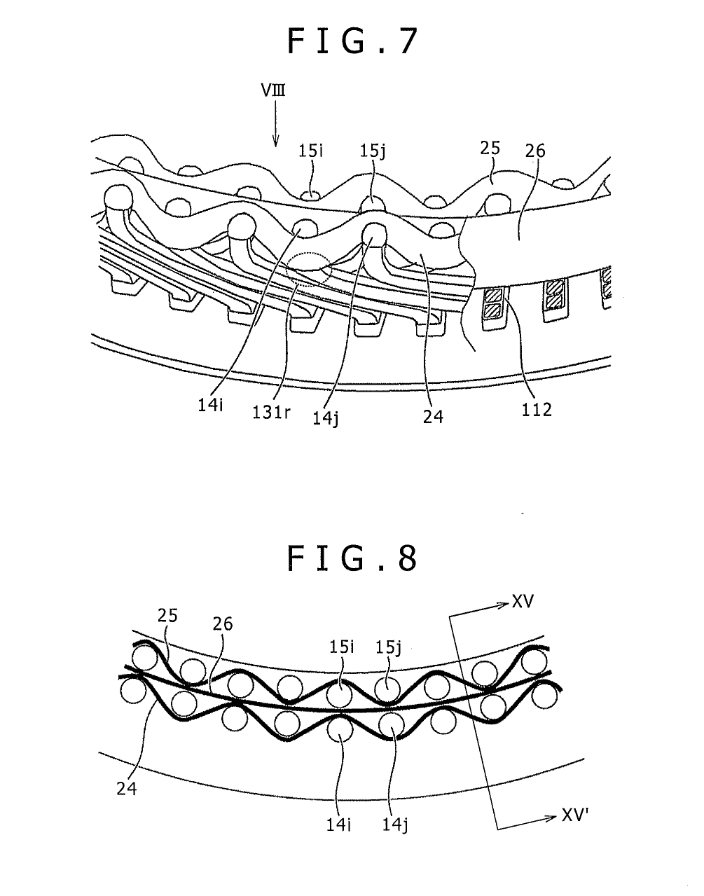

FIG. 7 shows another embodiment of the present invention. FIG. 8 shows a plan view of FIG. 7 seen from the VIII direction. In this embodiment, in addition to the insulating members 24 and 25 adjacent to each other in the radial direction, a third insulating member 26 is arranged. The third insulating member 26 is arranged between the connection terminals adjacent to each other in the radial direction. According to the present embodiment, when the distance between the connection terminals adjacent to each other in the radial direction, that is, between 14i and 15i or 15j and 15j, is smaller than the distance between the connection terminals adjacent to each other in the circumferential direction, that is, between 14i and 14j or 15i and 15j, it is possible to obtain an effect to increase the insulating performance between the connection terminals adjacent to each other in the radial direction. While the insulating members 24 and 25 can only be arranged to a position close to a bend portion 131r of the segment conductor 131, the insulating member 26 can be arranged to a depth in contact with the slot liner 112.

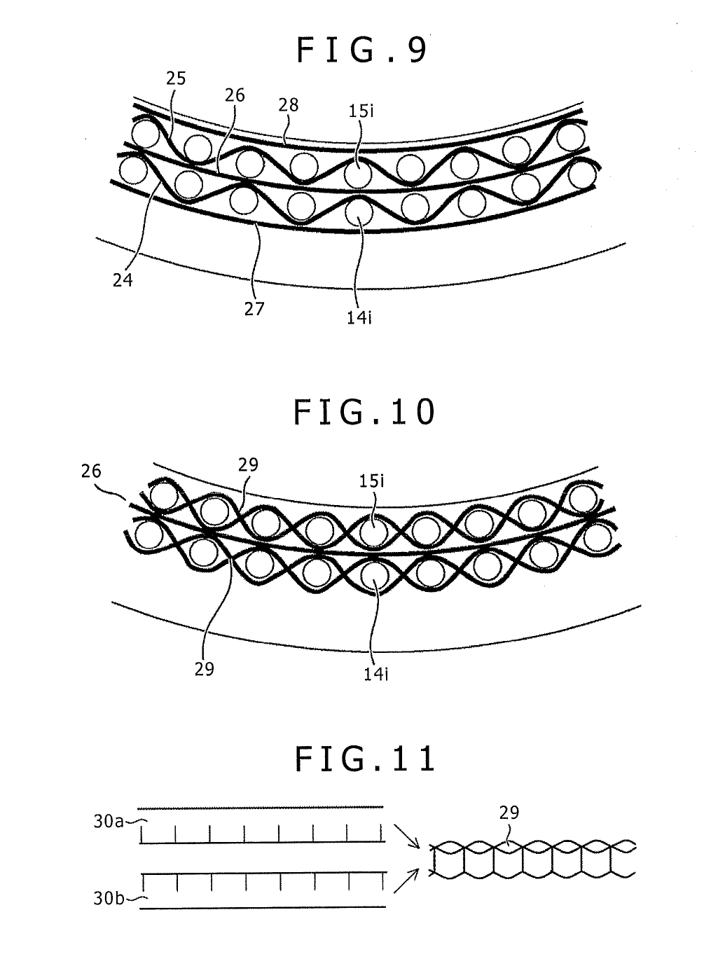

FIG. 9 shows a plan view of another embodiment of the present invention. In this embodiment, in addition to the insulating members 24, 25, and 26 between the connection terminals, fourth and fifth insulating members 27 and 28 are arranged. According to this embodiment, the circumference of the connection terminals 14i and 15i is surrounded by the insulating members, so that it is possible to prevent the connection terminals from being short-circuited by contacting an external conductive member and the insulation reliability is further improved. The conductive member here is a conductive abnormal small piece such as a wire piece, metal cutting powder, and carbonized organic matter, which do not originally exist around the electrical rotating machine but have entered inside the electrical rotating machine for some reason.

FIG. 10 shows a plan view of another embodiment of the present invention. Consecutive bag-shaped insulating members 29 are fitted to the connection terminals 14i and 15i. According to this configuration, the circumference of each connection terminal is surrounded by the insulating member, so that it is possible to prevent the connection terminals from being short-circuited by contacting an external conductive member. Although FIG. 10 shows an example in which the third insulating member 26 is arranged, the third insulating member 26 can be omitted.

FIG. 11 shows an example of a configuration of the consecutive bag-shaped insulating member 29. In this configuration example, the consecutive bag-shaped insulating member 29 is formed by combining thin insulating members 30a and 30b, in each of which a cut of a length of about half the width is made in the direction opposite to each other.

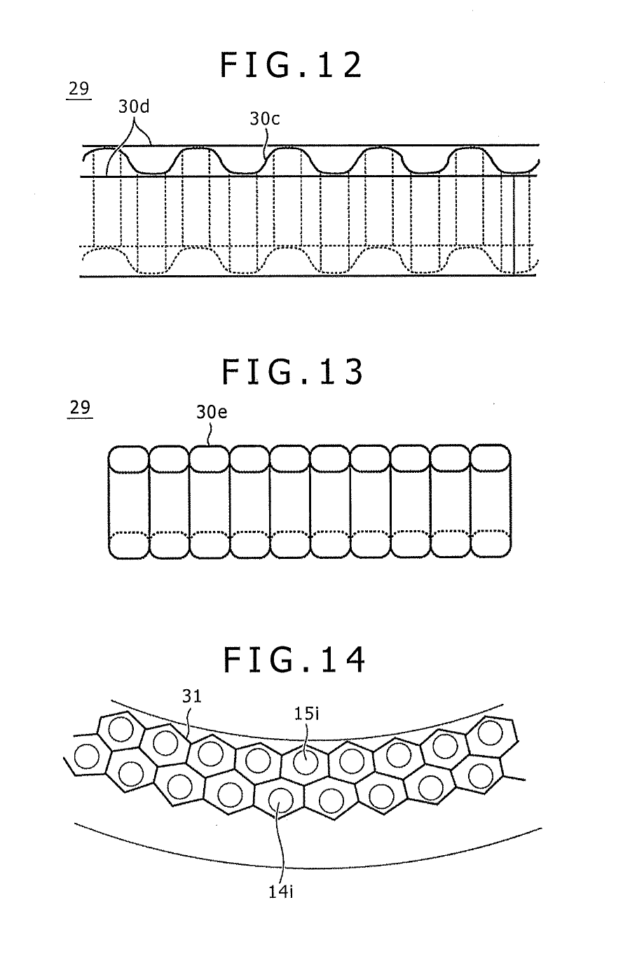

FIG. 12 is another configuration example of the consecutive bag-shaped insulating member 29. In this configuration example, the consecutive bag-shaped insulating member 29 is formed by attaching flat-shaped thin insulating members 30d respectively to both sides of a thin insulating member 30c which is folded into a corrugated shape.

FIG. 13 shows further another configuration example of the consecutive bag-shaped insulating member 29. In this configuration example, a plurality of cylindrical insulating members 30e are consecutively bonded to form the consecutive bag-shaped insulating member 29. Although the cylindrical insulating member 30e shown in FIG. 13 has a substantially rectangular cylindrical shape, the cylindrical insulating member 30e may have a circular shape or a polygonal shape such as a hexagonal shape.

The insulating members used in the embodiments shown in FIGS. 11 to 13 are preferable to be nonwoven fabric paper, a polymer film, and a composite of these materials.

FIG. 14 shows another embodiment of the present invention. FIG. 14 is an example in which a honeycomb-shaped insulating member 31 is used as the insulating member surrounding the connection terminals 14i and 15i of the coil. The honeycomb-shaped insulating member 31 has a high rigidity in the axial direction and can reduce a risk of deformation and breakage caused by a pressure force. In the present embodiment, the connection terminals 14i and the connection terminals 15i are shifted from each other by a half pitch in order to correspond to the positions of the holes of the honeycomb.

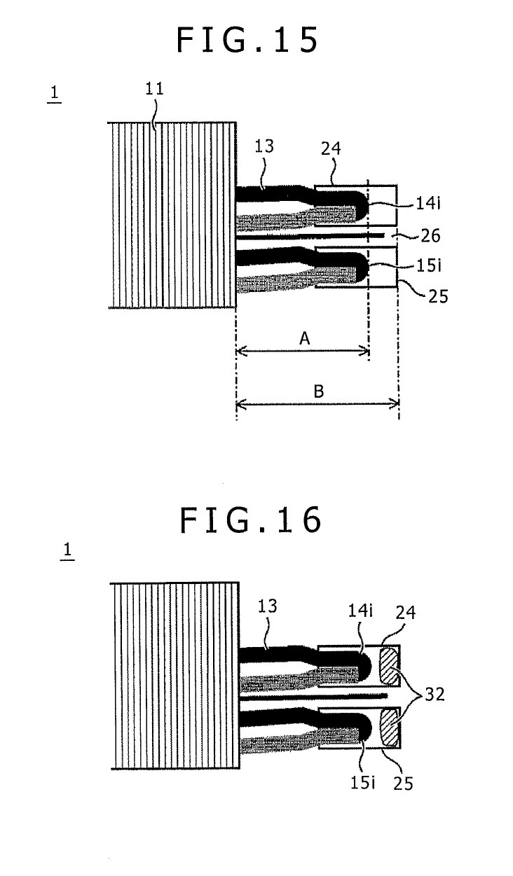

FIG. 15 shows another embodiment of the present invention. FIG. 15 is a cross-sectional view in a coil longitudinal direction of the electrical rotating machine stator 1 and is a view in the XV-XV′ direction in FIG. 8. In the stator core 11, the stator coil 13 is inserted into the slot not shown in FIG. 15 and the connection terminals 14i and 15i are formed. The insulating members 24, 25, and 26 are attached to the connection terminals. In the present embodiment, a relationship between the distance A from the edge of the stator core 11 to the connection terminal 14i or 15i and the distance B from the edge of the stator core 11 to the insulating member 24 or 25 is A<B. In other words, one end face of the insulating members 24 and 25 in the axial direction is more protruding outside in the axial direction than the connection terminals. A structure of the ground potential, such as a housing, is arranged around the stator, so that the above configuration can prevent electric breakdown between a coil terminal and the structure from occurring.

FIG. 16 shows another embodiment of the present invention. FIG. 16 is an example in which an insulating member 32 is provided at the end portion of the insulating members 24 and 25 surrounding the connection terminals 14i and 15i of the stator coil 13. According to this configuration, it is possible to make a space around the connection terminal a closed space, so that it is possible to prevent external conductive foreign matter from coming into contact with the connection terminal and there is an effect to improve the insulation reliability. Although FIG. 16 shows the embodiment as a modified example of the embodiment shown in FIG. 15, the insulating member 32 can be provided in any of the above embodiments. As the insulating member 32 used here, a putty-like insulating filling can be used. A method in which a fibrous insulating piece or a polymer film piece is arranged and fixed with resin is also effective.

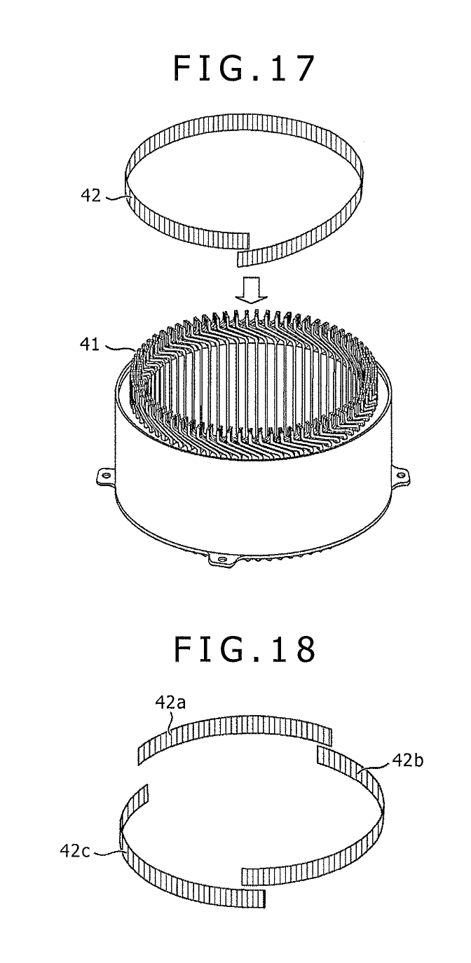

Hereinafter, an example of a method of attaching the insulating member to the connection terminal of the coil will be described. In FIG. 17, the stator coil connection terminals 41 collectively indicate the connection terminals 141 to 14n, 151 to 15n, 14i, and 15i shown in FIGS. 5 to 10 and 14 to 16, and the insulating member 42 collectively indicates the insulating members 24, 25, 26, 27, 28, 29, and 31 shown in FIGS. 5 to 15. FIG. 17 shows an example in which the insulating member 42 having a continuous body is fitted to the entire circumference of the connection terminals. In a conventional method in which an insulating member is individually attached to each connection terminal and resin is applied, there is a risk that the insulating member or the varnish comes off as a small piece in the following manufacturing process or during an operation of the electrical rotating machine. On the other hand, according to the embodiments of the present invention described so far, the insulating member 42 is a single component, so that the risk that a small piece comes off is small, the probability of machine failure decreases, and the reliability increases.

FIG. 18 shows an example in which there is a plurality of insulating members fitted to the connection terminals. In FIG. 18, as an example, there are three insulating members 42a, 42b, and 42c. In a large-sized electrical rotating machine, when trying to fit a single insulating member to the entire circumference, the size of the insulating member increases and there is a risk to damage the insulating member. It is possible to improve workability and reliability by dividing the insulating member into appropriate sizes. It is required that the connection portions of the plurality of insulating members overlap each other.

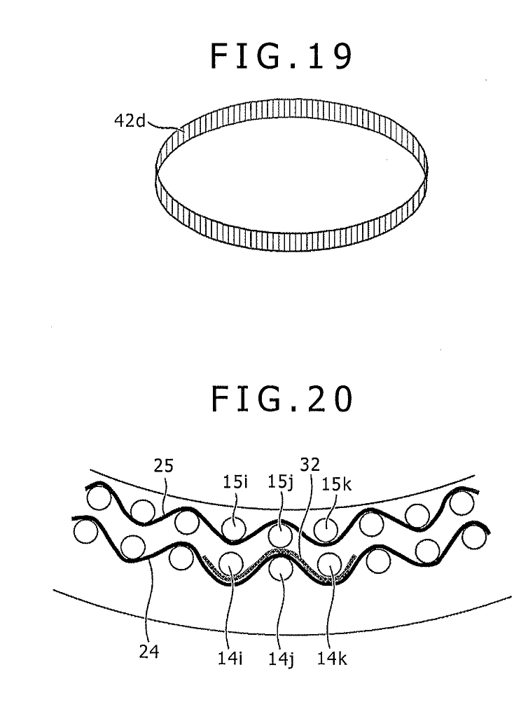

FIG. 19 shows an insulating member 42d formed into an endless shape. In this configuration, it is not necessary for the connection portions of the insulating members to overlap each other, so that an assembly operation can be easily performed by machine. The insulating member 42d having an endless shape can be formed by cutting an insulating tape to a predetermined length and gluing the both ends together. Further, the insulating member 42d can be easily formed by the consecutive cylindrical-shaped insulating member 29 or 31 shown in FIGS. 11 to 13. Further, the insulating member 42d can be realized as a molded body of an insulating resin.

Electrical rotating machines in recent years are often driven by inverter and the switching speed increases to reduce switching loss of the inverter, so that the rising speed of voltage increases. At this time, a short rise time voltage called an inverter surge occurs. Then, the distribution of voltage to each coil wrapped in series is transiently unbalanced due to a propagation delay of the voltage, so that the closer to the power supply the coil is, the higher the inverter surge voltage is. As a result, a voltage difference between a coil to which a high voltage is distributed and a coil adjacent to the coil increases, so that it is necessary to reinforce insulation at the connection terminals of the coils. In a conventional structure in which the connection terminals are coated with resin, it is difficult to partially reinforce dielectric strength.

FIG. 20 shows an example in which the dielectric strength is partially reinforced by application of the present invention. In the present embodiment, a case in which the connection terminal 14j becomes high potential is shown. In this case, it is necessary to reinforce the dielectric strength between the connection terminal 14j and the connection terminals 14i, 15i, 15j, 14k, and 15k which are adjacent to the connection terminal 14j. Therefore, in the present embodiment, in addition to the insulating members 24 and 25, an additional insulating member 32 is locally arranged. Here, the additional insulating member 32 is arranged along the insulating member 24 so as to locally increase the thickness of the insulating member 24. In other words, the insulating member 32 is arranged to a portion where it is desired to reinforce the dielectric strength (for example, a portion between the connection terminal that becomes high potential and the connection terminals adjacent to the connection terminal in the circumferential direction and in the radial direction). As a result, it is possible to improve the dielectric strength between the connection terminal that becomes high potential and the adjacent connection terminals, so that a highly reliable electrical rotating machine can be obtained.

The embodiments described above are the same at the point that, for example, the insulating member 42 (42a, 42b, 42c, or 42d) is arranged so as to weave between the connection terminals adjacent to each other in the circumferential direction. Here, “so as to weave between the connection terminals” indicates a state in which the insulating member 42 (42a, 42b, 42c, or 42d) having a length to be able to insulate at least three connection terminals continuously adjacent to each other in the circumferential direction is arranged between the connection terminals adjacent to each other in the circumferential direction as shown in FIG. 1 or between the connection terminals adjacent to each other in the circumferential direction and the radial direction as shown in FIG. 14.

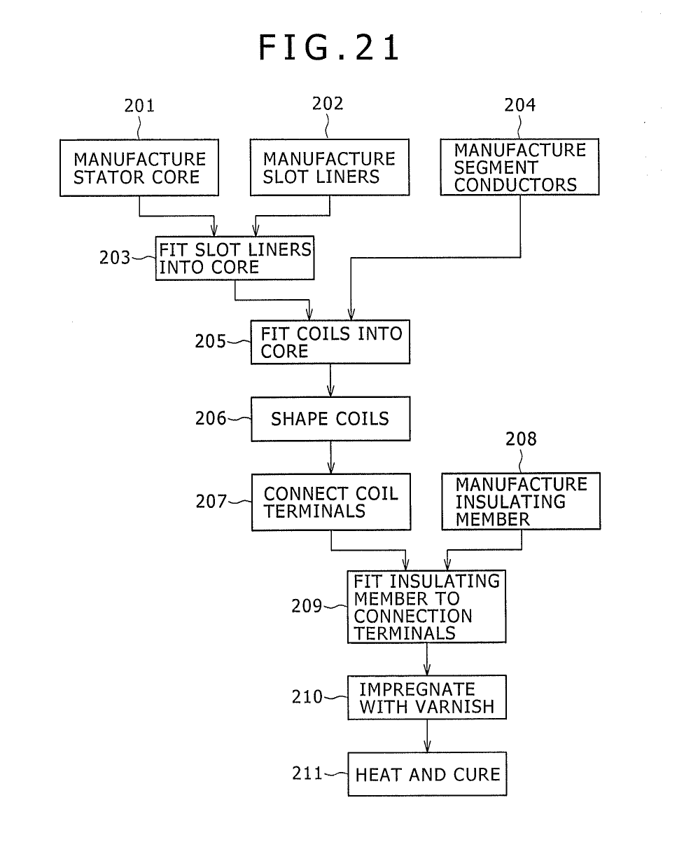

FIG. 21 shows an example of a process for manufacturing the electrical rotating machine stator 1 whose embodiments are described above. In step 201, the stator core 11 is manufactured from a magnetic material. The stator core 11 is formed by stamping out magnetic steel plates and stacking the plates or molding magnetic powder. In step 202, the slot liners 112 are formed by cutting out an insulating paper, a polymer film, or a laminated body of these, and performing molding. In step 203, the slot liners 112 are fitted into the stator core 11. Here, it is possible to fit the slot liners 112 into the stator core 11 while forming the slot liners 112.

In step 204, the segment conductors 131 are manufactured. The segment conductor 131 can be formed by cutting an enamel coated wire of copper or aluminum into a predetermined length, forming a shape, and peeling the coating on the end portions. The segment conductor 131 can also be formed by a bare wire of copper or aluminum. In step 205, coils including the segment conductors 131 are fitted into the stator core 11. In step 206, a connection side of the coil is folded into a predetermined shape. In step 207, terminals of the coils are connected to form an electric circuit. As a connection method, welding, silver alloy brazing, soldering, crimping, or the like is used.

The insulating member 42 (42a, 42b, 42c, or 42d) formed by an insulating paper, a polymer film, or a composite of these is manufactured in step 208 and fitted to the connection terminals in step 209. In step 210, the stator core 11, the slot liner 112, the stator coil connection terminals 41, and the insulating member 42 (42a, 42b, 42c, or 42d) are impregnated with varnish. As the varnish, a thermosetting resin such as an epoxy resin and an unsaturated polyester resin is appropriate. As an impregnation method, a dropping method and an immersion method are appropriate and a vacuum impregnation method may be used as part of the immersion method.

In step 211, all parts are heated and cured to fix the stator core 11, the slot liner 112, the stator coil connection terminals 41, and the insulating member 42 (42a, 42b, 42c, or 42d) are fixed, so that the electrical rotating machine stator 1 is formed. Conventionally, a two-step curing process is employed in which another insulating resin is coated on the stator coil connection terminals and heated and cured separately around the same time as the stator core, the slot liner, the stator coils are heated and cured with varnish. However, according to the present embodiment, there is an advantage that only one curing process is performed to complete the curing including the curing of the insulating member at the stator coil connection terminals.

### LIST OF REFERENCE SIGNS

1 Stator
11 Stator core
14 Connection terminal
24, 25, 26, 27, 28, 29, 31, 32, 42 Insulating member
41 Stator coil connection terminal
131 Segment conductor

1. A electrical rotating machine, stator coils being inserted into slots of a stator core, the stator coil being configured by electrically connecting a connection terminal of a segment conductor, and the stator core and the stator coils being fixed with resin,
wherein an insulating member is arranged so as to weave between the connection terminals adjacent to each other in a circumferential direction.

2. The electrical rotating machine according to claim 1,
wherein a front surface and a back surface of the insulating member are alternately in contact with welded connection terminals adjacent to each other.

3. The electrical rotating machine according to claim 1,
wherein a second insulating member is arranged between the connection terminals adjacent to each other in a radial direction.

4. The electrical rotating machine according to claim 1,
wherein a second insulating member is arranged locally along the insulating member.

5. The electrical rotating machine according to claim 1,
wherein the connection member is formed into consecutive cylindrical-shaped forms.

6. The electrical rotating machine according to claim 1,
wherein one end face of the insulating member in an axial direction is more protruding outside in an axial direction than the connection terminal.
